(19) United States
(12) Patent Application Publication
(10) Pub. No.: US 2023/0049222 A1
(43) Pub. Date: Feb. 16, 2023

(54) MAGNETIC LINEAR POSITION DETECTOR

(71) Applicant: Mitsubishi Electric Corporation, Tokyo (JP)

(72) Inventors: Makoto HIGASHINO, Tokyo (JP); Takeshi MUSHA, Tokyo (JP); Yoshinao TATEI, Tokyo (JP); Hisanori TORII, Tokyo (JP)

(73) Assignee: Mitsubishi Electric Corporation, Tokyo (JP)

(21) Appl. No.: 17/793,955

(22) PCT Filed: Mar. 10, 2020
(86) PCT No.: PCT/JP2020/010356

§ 371 Date: Jul. 20, 2022

(51) Int. Cl. G01D 5/14

(52) U.S. Cl. CPC G01D 5/145; G01D 2205/70

(57) ABSTRACT

A magnetic linear position detector includes a stator and a mover that is movable along a first direction with respect to the stator. One of the stator and the mover is provided with a magnetic detector. The other of the stator and the mover is provided with a magnet having a first face facing the magnetic detector. The first face is magnetized in such a manner that a magnetization direction changes in an arc shape around a magnetization center point. The magnetic detector is an element whose output changes depending on a direction of a magnetic field.

### FIELD

The present disclosure relates to a magnetic linear position detector capable of detecting a position of a mover that moves linearly.

### BACKGROUND

There are known magnetic linear position detectors capable of detecting a position of a mover that moves linearly. In a magnetic linear position detector, one of a mover and a stator is provided with a magnetic detector, and the other is provided with a magnet. Patent Literature 1 discloses a position detector including a magnet with alternately arranged S poles and N poles, and a magnetic sensor including a magnetoresistive element whose resistance value changes depending on a direction of a magnetic field received from the magnet.

### Citation List

### Patent Literature

Patent Literature 1: Japanese Patent No. 5343001

### SUMMARY

### Technical Problem

However, magnetic lines of force from the N pole to the S pole can have a shape close to an elliptical arc. In the case of elliptical-arc-shaped magnetic lines of force, some areas in which the change in the direction of the magnetic field is small with respect to the change in the relative position between a magnet and a magnetic detector can be generated. In this case, since the change in the resistance value of the magnetic detector also becomes small, the accuracy of position detection can be lowered. In particular, as the distance between the N pole and the S pole is increased in order to secure the stroke amount of a mover, the shape of the magnetic lines of force becomes an elliptical arc shape long in the moving direction of the mover, and areas in which the change in the magnetic field is small tend to be easily generated.

The present disclosure has been made in view of the above, and an object of the present disclosure is to obtain a magnetic linear position detector capable of improving the accuracy of position detection while using a magnetoresistive element whose resistance value changes depending on the direction of a magnetic field.

### Solution to Problem

In order to solve the above problems and achieve the object, the present disclosure includes a stator and a mover that is movable along a first direction with respect to the stator. One of the stator and the mover is provided with a magnetic detector. The other of the stator and the mover is provided with a magnet having a first face facing the magnetic detector. The first face is magnetized in such a manner that a magnetization direction changes in an arc shape around a magnetization center point. The magnetic detector is an element whose output changes depending on a direction of a magnetic field.

### Advantageous Effects of Invention

A magnetic linear position detector according to the present disclosure has an effect of being capable of improving the accuracy of position detection of a mover while using a magnetoresistive element whose resistance value changes depending on the direction of a magnetic field.

### BRIEF DESCRIPTION OF DRAWINGS

FIG. 1 is a perspective view illustrating a schematic configuration of a magnetic linear position detector according to a first embodiment.

FIG. 2 is a diagram illustrating a direction of a magnetic field received by a magnetic detector with respect to the displacement of a magnet according to the first embodiment.

FIG. 3 is a diagram illustrating a method of magnetizing the magnet according to the first embodiment.

FIG. 4 is a perspective view illustrating a schematic configuration of the magnetic linear position detector according to a second embodiment.

FIG. 5 is a diagram illustrating a direction of a magnetic field received by the magnetic detector with respect to the displacement of the magnet according to the second embodiment.

### DESCRIPTION OF EMBODIMENTS

Hereinafter, a magnetic linear position detector according to an embodiment of the present disclosure is described in detail with reference to the drawings. Note that, this disclosure is not limited by the embodiments.

### First Embodiment

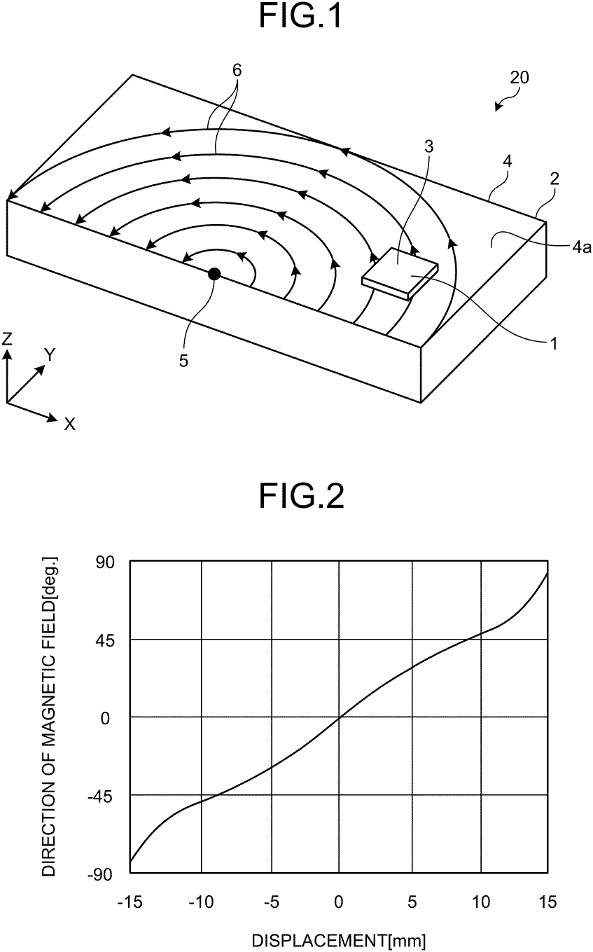

FIG. 1 is a perspective view illustrating a schematic configuration of a magnetic linear position detector according to a first embodiment. A magnetic linear position detector 20 includes a stator 1 and a mover 2. The mover 2 is linearly movable with respect to the stator 1 in the direction along an X-axis illustrated in FIG. 1. The direction along the X axis is a first direction. The stator 1 is provided with a magnetic detector 3. The mover 2 is provided with a magnet 4.

The magnet 4 has a first face 4a facing the magnetic detector 3. Note that a Z axis perpendicular to the first face 4a is defined. In addition, a Y axis perpendicular to the X axis and the Z axis is defined. In the following description, the direction along the X axis is referred to as a lateral direction, and the direction along the Y axis is referred to as a longitudinal direction.

The first face 4a is a rectangle having a long side parallel to the X axis, and the ratio of the long side to the short side is 2:1.

The magnet 4 is a polar anisotropic or isotropic magnet. The first face 4a of the magnet 4 is polar-anisotropically magnetized around a magnetization center point 5, and the magnetization direction is arc-shaped as indicated by an arrow 6. In the first embodiment, there is one magnetization center point 5, and the magnetization center point 5 is positioned at the center portion of one long side of the first face 4a.

The magnetic detector 3 is an element whose output changes with respect to the direction of the magnetic field received from the magnet 4. For example, the magnetic detector 3 is a spin valve giant magnetoresistance (GMR), a spin valve tunnel magnetoresistance (TMR), a rotation detection anisotropic magnetoresistance (AMR), or the like. Such a magnetic detector 3 is generally inexpensive, and the manufacturing cost of the magnetic linear position detector 20 can be suppressed.

FIG. 2 is a diagram illustrating a direction of a magnetic field received by the magnetic detector with respect to the displacement of the magnet according to the first embodiment. In FIG. 2, the horizontal axis represents the displacement of the magnet 4, and the vertical axis represents the direction of the magnetic field received by the magnetic detector 3. FIG. 2 shows an example in which the long side of the first face 4a of the magnet 4 is 30 mm. In addition, the displacement in a state where the magnet 4 is positioned on a line extending parallel to the Y axis from the magnetization center point 5 is set to 0.

As illustrated in FIG. 2, the direction of the magnetic field received by the magnetic detector 3 is different in the entire region along the longitudinal direction of the magnet 4. More specifically, in the process in which the displacement of the magnet 4 changes from -15 mm to 15 mm, the direction of the magnetic field received by the magnetic detector 3 changes by 180 degrees from -90 degrees (+Y direction) to 0 degrees (-X direction) and to +90 degrees (-Y direction). Therefore, since the output from the magnetic detector 3 is different in all displacements, the displacement of the magnet 4 can be determined as long as the output is known.

Here, as in the configuration disclosed in, for example, Patent Literature 1, when the same direction of the magnetic field appears a plurality of times with respect to the displacement of the magnet, the same output also appears a plurality of times from the magnetic detector. Therefore, for example, a sensor for identifying the same output that appears a plurality of times or a sensor for detecting the magnet being at the origin is further needed. In the first embodiment, since a sensor for identification as described above is unnecessary, the manufacturing cost of the magnetic linear position detector 20 can be suppressed. In addition, the operation of returning to the origin is unnecessary when the power of the magnetic linear position detector 20 is turned on, and the start-up operation of a drive device equipped with the magnetic linear position detector 20 can be further simplified, which means that the workability can be improved.

In addition, since the direction of the magnetic field changes in an arc shape, it is unlikely to generate areas in which the change in the direction of the magnetic field is small with respect to the change in the relative position between the magnet 4 and the magnetic detector 3, unlike the case with change in the direction of the magnetic field in an elliptical arc. Therefore, it is possible to detect the position of the mover more accurately regardless of the displacement of the magnet 4.

In addition, by setting the ratio of the long side to the short side of the first face 4a of the magnet 4 to 2:1, the diameter of the arc can be set to the length in the long side of the magnet 4, and the radius of the arc can be set to the length in the short side of the magnet 4 as illustrated in FIG. 1. As a result, it is possible to make a large region of the first face 4a as a magnetized region, that is, to efficiently magnetize the magnet 4 to have an arc-shaped magnetic field.

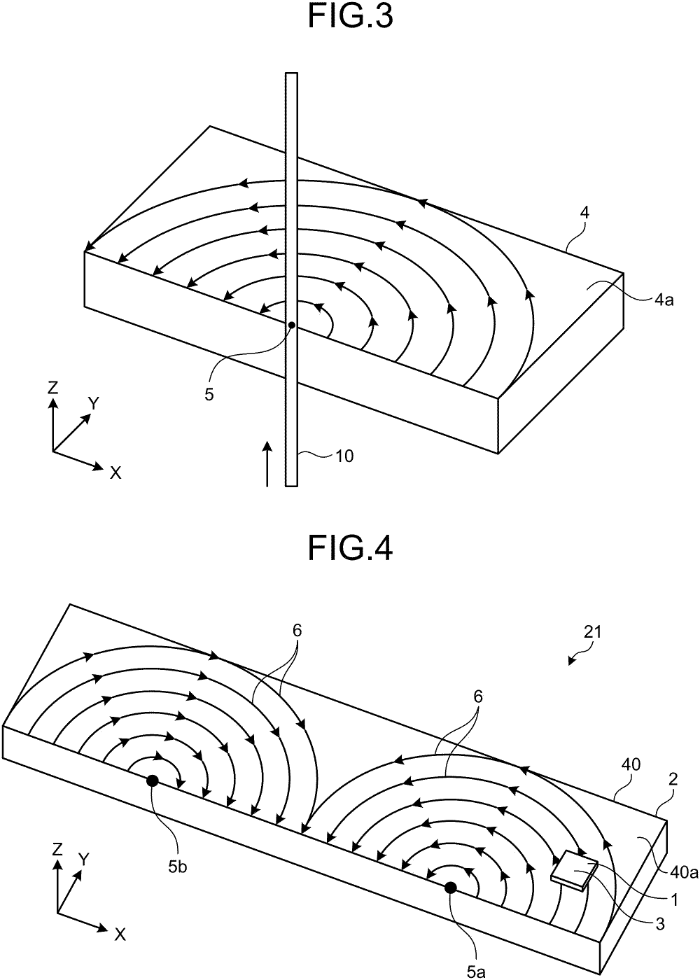

FIG. 3 is a diagram illustrating a method of magnetizing the magnet according to the first embodiment. As illustrated in FIG. 3, a linear electric wire 10 orthogonal to the first face 4a is arranged at the magnetization center point 5, and a linear current is caused to flow in the electric wire 10, whereby the magnet 4 is magnetized in such a manner that the magnetization direction changes in an arc shape around the magnetization center point 5. This utilizes the fact that an arc-shaped magnetic field is formed around the linear current. In the first embodiment, since the magnetization center point 5 is on the long side of the first face 4a, the electric wire 10 is arranged along the side face of the magnet 4. On the other hand, if the magnetization center point is in the plane of the first face 4a, a hole is formed at the magnetization center point 5 to pass the electric wire 10 through the hole, and a linear current is caused to flow in the electric wire 10. In addition, if the magnetization center point 5 is away from the magnet 4, the electric wire 10 is arranged at a position to become the magnetization center point 5 away from the magnet 4, and a linear current is caused to flow in the electric wire 10.

### Second Embodiment

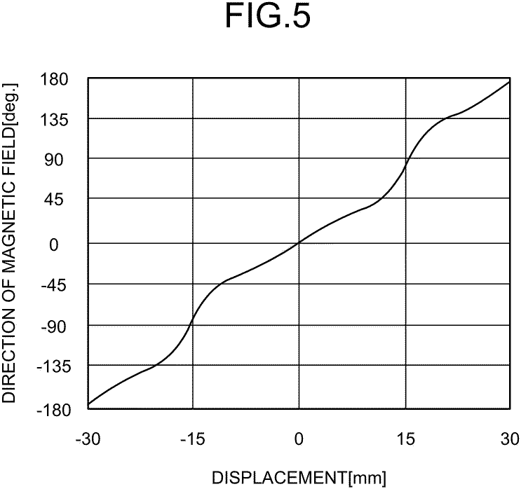

FIG. 4 is a perspective view illustrating a schematic configuration of the magnetic linear position detector according to a second embodiment. Note that components similar to those in the first embodiment are denoted by the same reference signs, and detailed description thereof is omitted.

A magnet 40 included in a magnetic linear position detector 21 according to the second embodiment is provided with two magnetization center points 5a and 5b. The magnetization direction in an arc shape around the magnetization center point 5a is counterclockwise. The magnetization direction in an arc shape around the magnetization center point 5b is clockwise.

A first face 40a of the magnet 40 is a rectangle having a long side parallel to the X axis, and the ratio of the long side to the short side is 4:1. The magnetization center points 5a and 5b are each positioned at ¼ of one long side of the first face 40a.

FIG. 5 is a diagram illustrating a direction of a magnetic field received by the magnetic detector with respect to the displacement of the magnet according to the second embodiment. In FIG. 5, the horizontal axis represents the displacement of the magnet 40, and the vertical axis represents the direction of the magnetic field received by the magnetic detector 3. FIG. 5 shows an example in which the long side of the first face 40a of the magnet 40 is 60 mm. In addition, the displacement in a state where the magnet 40 is positioned on a line extending parallel to the Y axis from between the magnetization center point 5a and the magnetization center point 5b is set to 0.

As illustrated in FIG. 5, the direction of the magnetic field received by the magnetic detector 3 is different in the entire region along the longitudinal direction of the magnet 40. More specifically, in the process in which the displacement of the magnet 4 changes from -30 mm to 30 mm, the direction of the magnetic field received by the magnetic detector 3 changes by 360 degrees from -180 degrees (+Y direction) to 90 degrees (-X direction) to 0 degrees (-Y direction) to +90 degrees (+X direction) and to 180 degrees (+Y direction). Therefore, since the output from the magnetic detector 3 is different in all displacements, the displacement of the magnet 40 can be determined as long as the output is known. Thus, since a sensor for detecting the magnet 40 being at the origin is unnecessary similarly to the first embodiment, the manufacturing cost of the magnetic linear position detector 21 can be suppressed. In addition, the operation of returning to the origin is unnecessary when the power of the magnetic linear position detector 21 is turned on, and the reliability of the magnetic linear position detector 21 can be improved.

In addition, since the direction of the magnetic field changes in an arc shape, it is unlikely to generate areas in which the change in the direction of the magnetic field is small with respect to the change in the relative position between the magnet 40 and the magnetic detector 3, unlike the case with change in the direction of the magnetic field in an elliptical arc. Therefore, it is possible to detect the position of the mover more accurately regardless of the displacement of the magnet 40.

In addition, by setting the ratio of the long side to the short side of the first face 40a of the magnet 40 to 4:1, twice the diameter of the arc can be set to the length in the long side of the magnet 40, and the radius of the arc can be set to the length in the short side of the magnet 40 as illustrated in FIG. 4. As a result, it is possible to make a large region of the first face 40a as a magnetized region, that is, to efficiently magnetize the magnet 40 to have an arc-shaped magnetic field.

As the magnetization method, an electric wire is arranged at each of the magnetization center points 5a and 5b, and a linear current is caused to flow in the electric wire similarly to the first embodiment. At this time, by making the current-applying direction different between the electric wire arranged at the magnetization center point 5a and the electric wire arranged at the magnetization center point 5b, the magnetization direction can be made different between the arc around the magnetization center point 5a and the arc around the magnetization center point 5b.

In addition, three or more arc-shaped magnetic fields may be provided side by side although a sensor or the like for identifying the same output appearing a plurality of times from the magnetic detector is needed, because the same direction of the magnetic field appears a plurality of times with respect to the displacement of the magnet. That is, three or more magnetization center points may be provided. For example, if three arc-shaped magnetic fields are provided side by side, the ratio of the long side to the short side of the first face 40a of the magnet 40 is set to 6:1, whereby the magnet 40 can be efficiently magnetized to have the arc-shaped magnetic fields. Therefore, when the number of arc-shaped magnetic fields is n (n is an integer), the ratio between the long side and the short side of the first face 40a of the magnet 40 is preferably 2n:1.

The configurations described in the above embodiments are merely examples and can be combined with other known techniques, the above embodiments can be combined with each other, and a part of the configurations can be omitted or changed without departing from the gist of the present disclosure.

### Reference Signs List

1 stator; 2 mover; 3 magnetic detector; 4, 40 magnet; 4a, 40a first face; 5, 5a, 5b magnetization center point; 6 arrow; 10 electric wire; 20, 21 magnetic linear position detector.

1. A magnetic linear position detector comprising:
a stator; and
a mover adapted to be movable along a first direction with respect to the stator, wherein
one of the stator and the mover is provided with a magnetic detector,
the other of the stator and the mover is provided with a magnet having a first face facing the magnetic detector,
the first face is magnetized in such a manner that a magnetization direction changes in an arc shape around a magnetization center point in the first face, and
the magnetic detector is an element whose output changes depending on a direction of a magnetic field.

2. The magnetic linear position detector according to claim 1, wherein
the first face is a rectangle having a long side parallel to the first direction, and
a ratio of the long side to a short side of the first face is 2n:1 (n is an integer).

3. The magnetic linear position detector according to claim 1, wherein
two magnetization center points are provided on the first face of the magnet,
the magnetization direction in an arc shape around one of the two magnetization center points is counterclockwise, and
the magnetization direction in an arc shape around the other of the two magnetization center points is clockwise.

4. The magnetic linear position detector according to claim 1, wherein
the magnet is magnetized in such a manner that the magnetization direction changes in the arc shape around the magnetization center point by arranging a linear electric wire orthogonal to the first face at the magnetization center point and causing a linear current to flow in the electric wire.

5. The magnetic linear position detector according to claim 2, wherein
the magnet is magnetized in such a manner that the magnetization direction changes in the arc shape around the magnetization center point by arranging a linear electric wire orthogonal to the first face at the magnetization center point and causing a linear current to flow in the electric wire.

6. The magnetic linear position detector according to claim 3, wherein
the magnet is magnetized in such a manner that the magnetization direction changes in the arc shape around the magnetization center point by arranging a linear electric wire orthogonal to the first face at the magnetization center point and causing a linear current to flow in the electric wire.
